(19) United States
(12) Patent Application Publication
(10) Pub. No.: US 2023/0072116 A1
(43) Pub. Date: Mar. 9, 2023

(54) TECHNIQUES FOR RECOMMENDING A TRAVEL MODE

(71) Applicant: BEIJING BAIDU NETCOM SCIENCE TECHNOLOGY CO., LTD., BEIJING (CN)

(72) Inventors: Hao CHEN, Beijing (CN); Runmei ZHAO, BEIJING (CN); Jizhou HUANG, BEIJING (CN)

(73) Assignee: BEIJING BAIDU NETCOM SCIENCE TECHNOLOGY CO., LTD., BEIJING (CN)

(21) Appl. No.: 18/049,782

(22) Filed: Oct. 26, 2022

Related U.S. Application Data
(63) Continuation of application No. PCT/CN2022/078235, filed on Feb. 28, 2022.

(30) Foreign Application Priority Data
Jul. 20, 2021 (CN) 202110819004.2

(51) Int. Cl. G06F 16/9537; G06F 16/9535; G06Q 30/02

(52) U.S. Cl. CPC G06F 16/9537; G06F 16/9535; G06Q 30/0283

(57) ABSTRACT

A method and an apparatus for recommending a travel mode, an electronic device; and a storage medium are provided. An implementation is: receiving a request from a user for querying a first point of interest; analyzing a travel type of the user based on the request; obtaining an alternative travel mode based on the travel type in combination with user information; calculating a travel cost corresponding to the alternative travel mode; and recommending at least one travel mode for the user according to the travel cost.

### CROSS REFERENCE TO RELATED APPLICATIONS

This application is a continuation of International Application No. PCT/CN2022/078235, filed on Feb. 28, 2022, which claims priority to Chinese patent application Ser. No. 202110819004.2, filed on Jul. 20, 2021. The entire contents of the aforementioned applications are hereby incorporated by reference in their entireties for all purposes.

### TECHNICAL FIELD

The present disclosure relates to the field of computer technology, in particular to the fields of intelligent traffic, intelligent search, big data analysis, etc., and in particular to a method and an apparatus for recommending a travel mode, an electronic device, and a storage medium.

### BACKGROUND

In the prior art, users obtain relevant factors of travel cost through multiple platforms or multiple channels, and finally select an optimal travel mode after calculating and comparing. The process is time-consuming and labor-intensive, and it is easy to make wrong travel decisions due to poor consideration of the users, resulting in a poor travel experience. In this regard, there is no effective solution in the related art.

### SUMMARY

The present disclosure provides a method and an apparatus for recommending a travel mode. an electronic device, and a storage mediwn.

In accordance with an aspect of the present disclosure, a method for recommending a travel mode is provided, including:
receiving a request from a user for querying a first point of interest;
analyzing a travel type of the user based on the request;
obtaining an alternative travel mode based on the travel type in combination with user information;
calculating a travel cost corresponding to the alternative travel mode; and
recommending at least one travel mode for the user according to the travel cost.

In accordance with another aspect of the present disclosure, an electronic device is provided, including:
at least one processor; and
a memory in communication connection with the at least one processor; wherein
the memory stores instructions executable by the at least one processor that, when executed by the at least one processor, cause the at least one processor to perform the method of any of the embodiments of the present disclosure.

According to another aspect of the present disclosure, there is provided a non-transitory computer-readable storage medium storing computer instructions, the computer instructions executed to cause a computer to perform the method of any of the embodiments of the present disclosure.

The advantages or beneficial effects of the technical solutions of the embodiment of the present disclosure include: according to the technology of the present disclosure, the travel type can be intelligently determined based on the user's request for querying the first point of interest. Then, relevant factors can be comprehensively collected and analyzed based on different travel types, so as to accurately calculate the travel cost. Through a humanized comparison, travel modes can be obtained quickly and accurately for selection by the user, and recommended to the user, which provides great convenience for the user to make the travel decision.

It should be appreciated that the content described in this section is not intended to identify critical or important features of the embodiments of the present disclosure, nor is it intended to limit the scope of the present disclosure. Other features of the present disclosure will be apparent from the following description.

The above overview is only for the purpose of the specification and is not intended to he limited in any way. In addition to the schematic aspects, embodiments and features described above, further aspects, embodiments and features of the present application will be apparent with reference to the accompanying drawings and the following detailed description.

### BRIEF DESCRIPTION OF THE DRAWINGS

In the drawings, unless stated otherwise, the same reference numerals refer to the same or similar components or elements throughout the drawings. The drawings are not necessarily scaled. It should be appreciated that these drawings illustrate only some embodiments disclosed in accordance with the present application and should not be construed as limiting the scope of the present application.

FIG. 1 is a schematic diagram of a method for recommending a travel mode according to an embodiment of the present disclosure;

FIG. 2 is a schematic diagram of travel-related devices around a point of interest according to an embodiment of the present disclosure;

FIG. 3 is a schematic diagram of a method for recommending a travel mode according to another embodiment of the present disclosure;

FIG. 4a is a schematic diagram of travel recommendation interfaces under different weather conditions according to an embodiment of the present disclosure;

FIG. 4b is a schematic diagram of travel recommendation interfaces for different points of interest according to an embodiment of the present disclosure;

FIG. 5 is a schematic diagram of a method for recommending a travel mode according to yet another embodiment of the present disclosure;

FIG. 6 is a schematic diagram of a travel recommendation interface for multiple points of interest according to an embodiment of the present disclosure;

FIG. 7 is a hierarchical schematic diagram of a method for recommending a travel mode according to an embodiment of the present disclosure;

FIG. 8 is a schematic diagram of an apparatus for recommending a travel mode according to an embodiment of the present disclosure;

FIG. 9 is a schematic diagram of an apparatus for recommending a travel mode according to another embodiment of the present disclosure; and

FIG. 10 is a block diagram of an electronic device for implementing the method for recommending the travel mode according to an embodiment of the present disclosure.

### DETAILED DESCRIPTION

Example embodiments of the present disclosure are described below in combination with the accompanying drawings, where various details of the embodiments of the present disclosure are included to facilitate understanding, and should only be considered as examples. Therefore, those of ordinary skill in the art should recognize that various changes and modifications can be made to the embodiments described herein, without departing from the scope and spirit of the present disclosure. Likewise, the description of well-known functions and structures is omitted in the following description for clarity and conciseness.

The term “and/or” used herein refers to an association relationship that describes the associated objects, indicating three relationships. For example A and/or B may indicate A, A and B, and B. The term “at least one” used herein refers to any one of a variety or any combination of at least two of a variety. For example, including at least one of A, B, and C may indicate including any one or more elements selected from the group consisting of A, B and C. The terms “first” and “second” used herein refer to and distinguish a plurality of similar technical terms, and are not intended to define an order of the elements, or to define that there are only two elements. For example, a first feature and a second feature refer that there are two categories of features/two features, where the first feature may be one or more features and the second feature may also be one or more features.

In addition, numerous specific details are set forth in the detailed implementation below in order to better illustrate the present disclosure. It will be appreciated for those skilled in the art that the present disclosure may be implemented without certain specific details. In some instances, methods, means, elements, and circuits well known to those skilled in the art have not been described in detail in order to highlight the subject matter of the present disclosure.

POI is an abbreviation of “Point of Interest”. In a geographic information system, a POI may be a house, a shop, a bus stop, etc. In a practical scenario, the user is required to first search for relevant point of interests on a POI retrieval platform based on their own needs, next to determine various travel routes, then to query relevant factors that affect the travel, such as weather, traffic restriction, public transportation congestion, whether there are parking lots, gas stations, etc. nearby, and finally to make a travel decision based on the above. In general, the above operations needs to be completed separately on different pages, even on different platforms. For instance, the point of interest is queried on a first page, a travel route is queried on a second page or another website, and relevant factors that affect the travel are queried on a third page or the remaining plurality of websites. After collecting all the relevant information by himself, the user will make a final travel decision based on the information. The decision-making process is tedious and time-consuming, and it is often impossible to make an optimal travel decision due to the incomplete collection of relevant information.

In addition, although some websites can recommend the travel mode for the user based on the departure and destination of the user and according to the time spent under the travel mode, so as to help the user make the travel decision to a certain extent, invalid recommendations will be generated due to the simplistic considerations in the recommendation process. For example, driving may he preferably recommended as a traffic mode for non-owner users, without considering the travel cost for such traffic mode caused by factors such as parking, etc. Further, there is no clear recommendation reason for the user to understand whether such a recommendation is suitable.

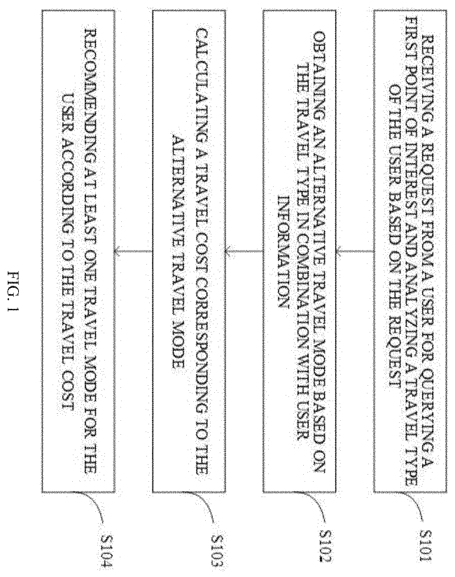

According to an embodiment of the present disclosure, a travel recommendation method is provided. As shown in FIG. 1, the method may include:

S101: receiving a request from a user for querying a first point of interest, and analyzing a travel type of the user based on the request;

In an example, the request by the user to query the first point of interest may be a specific action by the user to query a certain point of interest on any POI-related platform, such as querying a certain Sichuan restaurant. The query request is received, and then the specific travel type of the user is determined with the specific information of the first point of interest in combination with the relevant information of the user, so as to further clarify the information that the user actually expects to obtain. In a case where the first point of interest queried by the user is a railway station in a different place, a departure demand of the user is determined, that is, the user actually expects to obtain the travel mode from the railway station. In a case where the first point of interest queried by the user is a local Sichuan restaurant, an arrival demand of the user is determined, that is, the user actually expects to obtain the travel mode to the Sichuan restaurant. In a case where the first point of interest queried by the user is a Sichuan restaurant in a different place, both a departure demand and an arrival demand of the user may be determined.

S102: obtaining an alternative travel mode based on the travel type in combination with user information.

In an example, the user information includes, but is not limited to, at least one of: (1) vehicle owner information, i.e., whether the user owns a vehicle, the type of the vehicle, the location of the vehicle, whether the vehicle is a new energy vehicle or a fuel vehicle, and the like; relevant information about whether the user has a motorcycle, a bicycle, and other non-motor vehicles may also be obtained; (2) travel preference information, i.e., how the user prefers to travel. The preference information may be travel preferences at different times and in different scenarios. For example, on weekdays, the user prefers to travel by public transportation even though lie has a vehicle, or if the user often drinks when he goes out for dinner, the user prefers to travel by taxi, etc. even though he has a vehicle; (3) information about the user's permanent residence, which may be a permanent city, home address, company address of the user, etc. It should be noted that the vehicle owner information described above can be set by the user, or obtained by mining and analyzing the user's historical data.

The alternative travel mode is obtained based on the travel type combined with the specific information about the user. The alternative travel mode may be a travel mode that the user can select or is used to select. For example, if the user will go to a nearby Sichuan restaurant, but the user does not own a vehicle and is used to travel by bus, the alternative travel mode may include taking bus, cycling, etc. instead of self-driving. For example, if the user will go to a restaurant in a non-resident city, even if the user owns a vehicle, self-driving will not considered as the alternative travel mode. It should be noted that the alternative travel modes should be selected as much as possible, without omitting the possible travel modes.

S103: calculating a travel cost corresponding to the alternative travel mode.

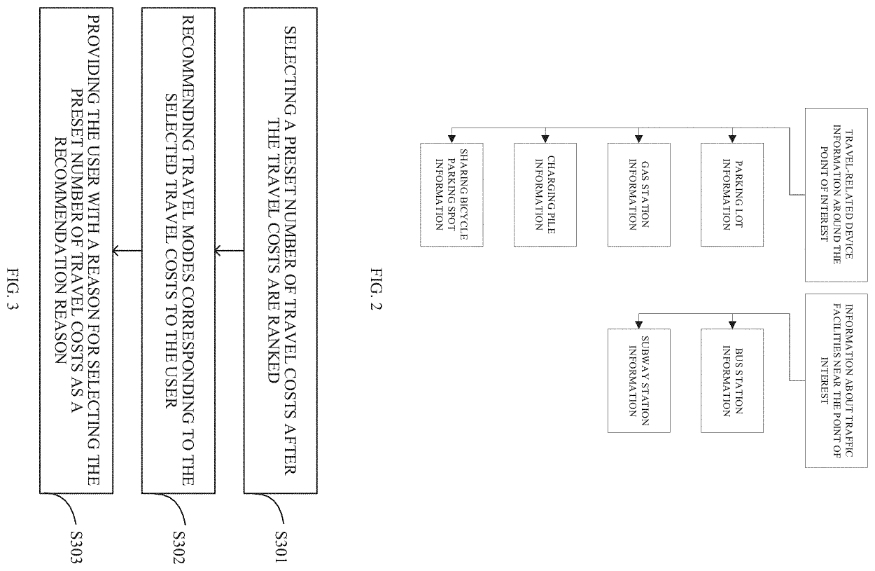

In an example, a travel cost corresponding to the alternative travel mode may be calculated according to the user information, the related information of the point of interest, and the travel impact information. Specifically, the user information, as described in step S102, may include vehicle owner information, travel preference information, or permanent residence information; the related information of the point of interest is mainly the travel-related hardware device conditions related to the point of interest itself or nearby the point of interest, which may specifically include travel-related device information around the point of interest and information about traffic facilities near the point of interest. As shown in FIG. 2, the travel-related device information around the point of interest includes, but is not limited to, at least one of: (1) parking lot information, including: parking lot location, charging information, user preferences for parking (for example, if there are two parking lots A and B around a point of interest, the user is provided with historical parking preferences of the two parking lots, such as 60% of users select the parking lot A for parking and 35% of users select parking lot B for parking), etc.; information about available parking spaces may also be provided; (2) gas station information, including information such as a location of the gas station, an oil number, an oil price, current queueing information; (3) charging pile information, including: fast charging, slow charging, available charging piles, and the like; (4) sharing bicycle parking spot information, including: parking spot location, etc. The travel-related device information around the point of interest, as described above, can be obtained through user behaviors, or can be obtained directly from a third-party website. The obtaining method or channel is not limited herein.

As shown in FIG. 2, the information about traffic facilities near the point of interest mainly includes station information of public transportation, such as bus stations, subway stations, etc. Each type of the station information specifically includes at least one of: (1) basic information, including station name, line, distance from the current point of interest, etc.; (2) real-time information, including degree of crowdedness, arrival time of the next bus, etc. The above information may be generated offline from map data on demand, or may be obtained from a third-party website, which is not limited herein.

Travel impact information is mainly environmental condition information that affects travel, which is also referred to as spatio-temporal scene information, such as user travel time, (whether it is a festival, whether it is during the rush hour, etc.); weather information (whether it is rainy and snowy, etc).

In the above examples, the travel cost is calculated based on a combination of the user information, the related information of the first point of interest and the travel impact information. Various factors that may affect the travel cost are comprehensively taken into account, based on which the cost can be calculated more accurately, thereby achieving a personalized and intelligent travel recommendation.

In an example, the travel cost may include at least one of a time cost, a money cost, and a difficulty cost. In the process of calculating the travel cost, the cost may be calculated in three ways: (1) time cost calculation (also called general travel cost calculation). In the step of calculating the time cost, a travel route is generated based on the location of the user and the location of the point of interest, or the location of the point of interest of the user and the location of nearby traffic facilities, a travel distance is then calculated, and a travel time is estimated based on traffic conditions. It should be noted that there may be multiple routes in this step, and a corresponding travel time is calculated for each route. In the case of a travel by bus, not only the time for travelling on the road is to be calculated, but also the waiting time may be estimated based on the degree of crowdedness of vehicles and the distance between vehicles; (2) money cost calculation. In the step of calculating the money cost, corresponding money cost is calculated for a specific transportation mode. For example, when a taxi is selected as the travel mode, the cost for taking the taxi needs to be calculated; when self-driving is selected as the travel mode, the cost for parking needs to be calculated; and when a bus is selected as the travel mode, the cost for bus tickets needs to he calculated; (3) difficulty cost calculation. In the step of calculating the difficulty cost, a specific travel cost is calculated for a specific transportation mode. For example, it is very inconvenient to ride under a rainy and snowy weather, so the value of the special cost for riding is set to be higher, indicating that such a travel mode is very difficult. For example, if there is no parking lot near the restaurant, the value of the special cost for self-driving is set to he higher, indicating that such a travel mode is difficult. Based on the above calculation manners, travel costs corresponding to the alternative travel modes are calculated. In this example, the travel cost will he considered in various respects, and calculated separately to estimate the cost more accurately and provide a better data basis for later recommendation of the travel mode for users.

S104: recommending at least one travel mode for the user based on the travel cost.

In an example, the travel costs calculated in step S103 are ranked according to the actual needs of the user, and then at least one travel mode is selected to be recommended to the user based on the ranking result. For example, if the first point of interest queried by the user is a train station in a different place, which indicated a departure demand, then the information about a plurality of bus stations and subway stations near the train station is obtained and the corresponding time costs, money costs, and difficulty costs are separately calculated. Then the results from the calculations are ranked, and at least one navel mode with a low money cost and a low difficulty cost is selected to be recommended to the user. If the user's specific ranking preferences when making decisions are obtained based on the user's habits, then the ranking is based on the user's specific preferences. For example, if the user is only concerned with time, then the time costs are weighted in the ranking result, i.e., recommendation is mainly based on the ranking result of the time costs.

In the above embodiment, the travel type may be intelligently determined based on the user's request to query the first point of interest. Based on different travel types, the relevant factors are then comprehensively collected and analyzed for accurately calculating the travel cost. A user-friendly comparison is then performed, and finally available travel modes for selection by the user are quickly and accurately obtained and recommended to the user, thereby providing great convenience for the users to make the travel decision,

According to an embodiment of the present disclosure, another method for recommending a travel mode is provided, wherein step S101 includes:
receiving a request from a user for querying a first point of interest, and determining a location and a type of the first point of interest;
analyzing the location of the first point of interest and a location of the user, and determining the travel type of the user as departure or arrival in combination with the type of the first point of interest.

In an example, the location of the first point of interest may include location coordinates of the first point of interest, and the type of the first point of interest may be a station or non-station. The location of the user includes a current location of the user. If the current location of the user and the location of the first point of interest are within a preset range (e.g., in the same city or in the same area), it is determined that the travel type of the user is arrival demand, i.e., the user expects to travel from the current location to the first point of interest. If the current location of the user and the location of the first point of interest exceed the preset range, and the type of the first point of interest is a station, it is determined that the travel type of the user is departure demand, i.e. the user expects to depart from the first point of interest. If the current location of the user and the location of the first point of interest exceed the preset range, and the type of the first point of interest is non-station, it is determined that there are two travel types of the user, i.e., the user has both a departure demand and an arrival demand. In this example, the user's actual demand of travel may be estimated based on the user's actions of querying the point of interest, thereby providing the user with more accurate travel mode recommendations and improving the user experience.

Further, at least one alternative travel mode conforming to travel habits of the user is obtained in a case where the travel type is departure, in which the user departs from the first point of interest, and
at least one alternative travel mode conforming to the travel habits of the user is obtained in a case where the travel type is arrival, in which the user arrives at the first point of interest.

In an example, in the case where the travel type is departure, at least one alternative travel mode conforming to travel habits of the user, in which the user departs from the first point of interest, is obtained in combination with the user information; and in the case where the travel type is arrival, at least one alternative travel mode conforming to the travel habits of the user, in which the user arrives at the first point of interest, is obtained in combination with the user information.

Specifically, “the travel mode that conforms to the travel habits of the user” is a mode of transportation that is commonly used or can be taken by the user. For example, if the user owns a vehicle, his habitual travel mode includes self-driving. If the user often travels by public transportation before, his habitual travel mode includes public transportation. The habitual travel mode may be obtained through the user information, which may be implemented with reference to the description in step S102 and will not described here. In this example, alternative travel modes may be comprehensively obtained for the travel type of departure and arrival in combination with the user information, which may be a good data basis for accurate travel recommendations in the future.

According to an embodiment of the present disclosure, another method for recommending a travel mode is provided, as shown in FIG. 3. In this method, step S104 may specifically include:
S301, selecting a preset number of travel costs after the travel costs are ranked;
S302, recommending travel modes corresponding to the selected travel costs to the user.

In an example, based on the multiple costs calculated in step S103, a comparison among multiple alternative travel modes is performed and then the travel modes are ranked. Rules for ranking may be based on default rules, such as ranking by time cost (from fast to slow), ranking by money cost (from cheap to expensive), or ranking by difficulty cost (from easy to hard); or a comprehensive ranking is performed based on pre-set rules, for example, if the user is more concerned with time, the weight of time cost in ranking is greater and if the user is more concerned with money, the weight of money cost in ranking is greater. After the overall ranking, the preset number of travel costs are selected (for example, the lowest travel cost or the lowest three travel costs are selected), and then the corresponding travel modes are recommended to the user. In this example, the multiple calculated costs may he flexibly ranked according to the actual needs of the user, which can better meet the needs of the user and achieve real intelligent recommendation.

Step S104 may further include the following step after step S302:
S303, providing the user with a reason for selecting the preset number of travel costs as a recommendation reason.

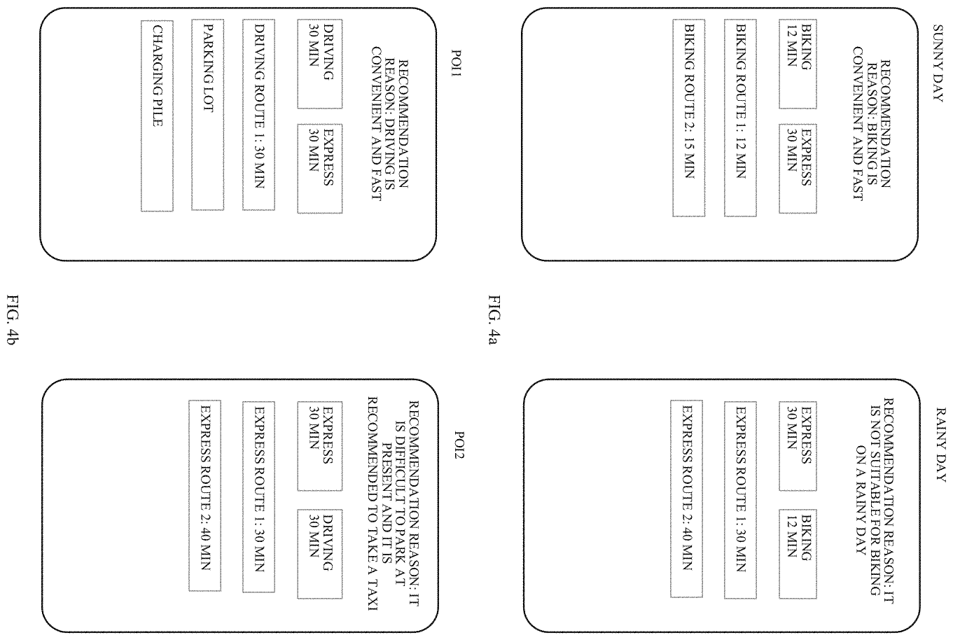

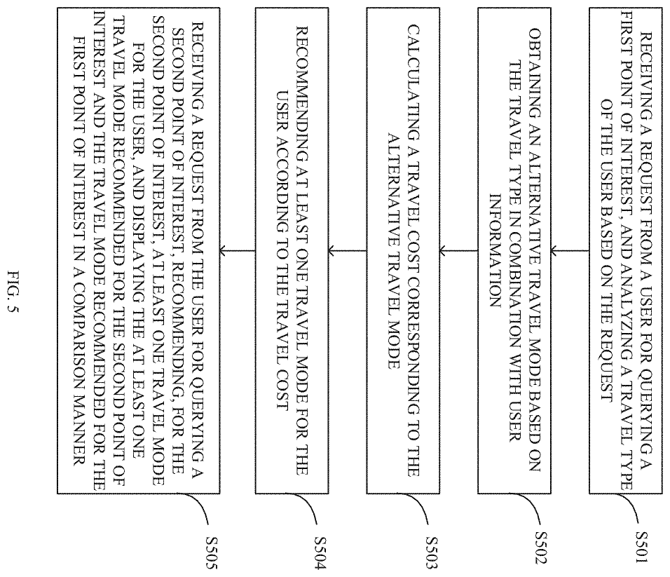

As described in step S302, the preset number of travel costs are selected based on certain preset rules or reasons, such as the least cost, the least time, or the rainy and snowy weather not suitable for biking ,etc. The preset rules or reasons are then provided to the user together with the travel mode. As shown in FIG. 4a, for the user who does not own a vehicle, the preferred recommended travel mode in sunny days is biking as it is convenient and fast; while the recommended travel mode in rainy days is express (taking a taxi) as it is raining outside and it is not suitable for biking. The recommendation for the user who owns a vehicle is shown in FIG. 4b. For the POI1, self-driving is recommended as it is convenient to park; for the POI2, since it is detected that it is hard to park at the destination, the user is recommended to travel with express under the condition of the same time consumption. In this example, a clear recommendation reason is given, so that the user can more intuitively determine whether the recommended method is suitable for him.

According to an embodiment of the present disclosure, yet another method for recommending a travel mode is provided. As shown in FIG. 5, the method includes:
S501, receiving a request from a user for querying a first point of interest, and analyzing a travel type of the user;
S502, obtaining an alternative travel mode based on the travel type in combination with user information;
S503, calculating a travel cost corresponding to the alternative travel mode;
S504, recommending at least one travel mode for the user based on the travel cost; and
S505, receiving a request from the user for querying a second point of interest, recommending at least one travel mode for the user for the second point of interest, and displaying, in a comparison manner, the at least one travel mode recommended for the second point of interest and the at least one travel mode recommended for the first point of interest.

The above described steps S501-S504 are the same as steps S101-S104, and are therefore not described herein.

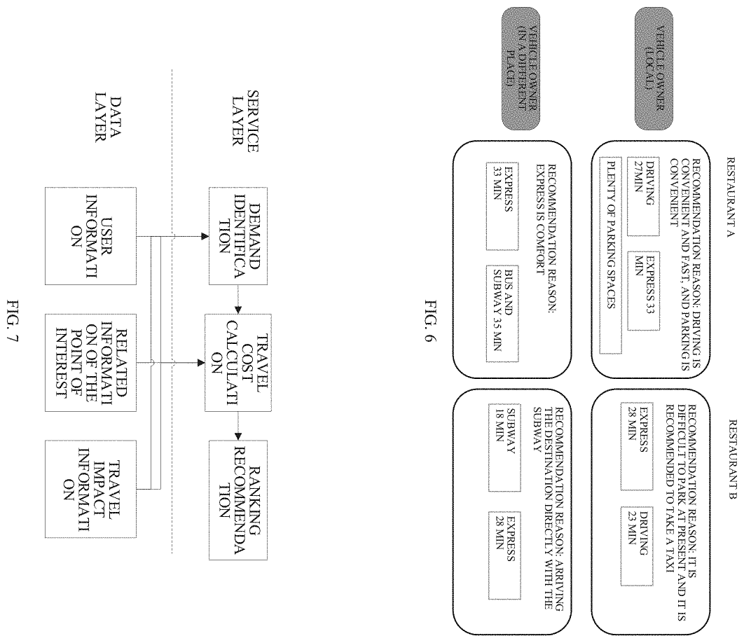

Regarding step S505, in an example, the user may continuously query a plurality of points of interest, for example, if the user expects to eat Sichuan cuisine, he may query a plurality of Sichuan restaurants. Based on each point of interest queried by the user, at least one recommended travel mode is obtained with steps S101-S104, and then the travel modes are compared and displayed on the same page, as shown in FIG. 6. In the case where the user queries two points of interest, i.e., Restaurant A and Restaurant B, if the user owns a vehicle and the vehicle is in the local area (i.e., the vehicle and the points of interest queried by the user are in the same area), at least one travel mode is recommended respectively for Restaurant A and Restaurant B, and the corresponding recommendation reasons are given; if the user owns a vehicle, but the vehicle is not in the local area, at least one travel mode is also recommended respectively for Restaurant A and Restaurant B, and the corresponding recommendation reasons are given. After horizontal comparison, the user may decide the final travel mode. In this example, the user can make horizontal comparisons among multiple alternative destinations, and select the destination based on the travel cost, thereby obtaining the best travel experience.

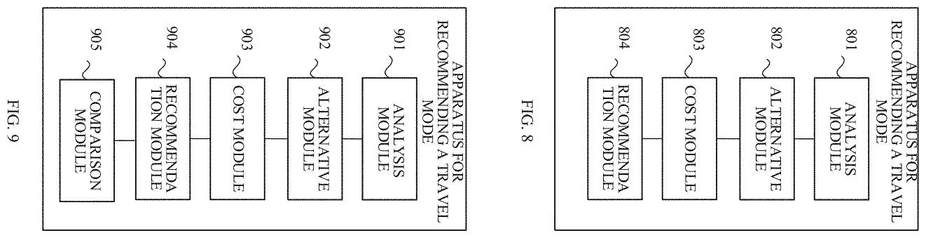

According to an embodiment of the present disclosure, as shown in FIG. 7, the solution in the present disclosure is mainly divided into a service layer and a data layer in terms of the technical implementation. The data layer includes data such as user information, related information of the point of interest and travel impact information. The user information as described in step S102 includes vehicle owner information, travel preference information and user's permanent residence information. The related information of the point of interest as described in step S103 includes travel-related device information around the point of interest and information about traffic facilities near the point of interest. The travel impact information includes some spatio-temporal scene information, including all the information related to time and location in the present disclosure, such as the user's current location, time, weather information, and the like.

The actions performed by the service layer include demand identification, travel cost calculation, and ranking recommendation, wherein the demand identification enables identification of the specific demand for travel of the user based on relevant data in the data layer, such as determining the travel type, the travel cost calculation enables cost calculation of multiple travel modes based on relevant data in the data layer and results of demand identification, and the ranking recommendation enables ranking of costs and recommendations of corresponding travel modes based on the results of the travel cost calculation.

In an example, the method of the present disclosure may obtain or generate a large amount of data that is frequently accessed throughout the computing process. In order to realize the above embodiments more efficiently and with low cost, a multi-level cache mechanism is required to be established in engineering implementation, as shown in Table 1 below. Caches include in-application cache and out-of-application cache, wherein the in-application cache is a cache that only stores data related to this application program, but the out-of-application cache also stores caches of other applications. Compared with the out-of-application cache, it is faster to obtain or store data from the in-application cache. The in-application cache is divided into two levels. The first level is in-application accurate cache. The caching content includes the user, the current time, the current position and the current POI, where the current time is accurate to seconds and the current position is accurate to specific coordinates. The other level is in-application fuzzy cache. The caching content includes the current time, the current position and the current POI, wherein the current time of the in-application fuzzy cache is accurate to hours, and the current position is a predetermined area including the current position, such as the street where the current position is located, or a circular area with the coordinates of the current position as the center of the circle and a radius of a predetermined value. The expiration time of the accurate cache is shorter than that of the fuzzy cache, that is, the accurate cache will expire first, and then the fuzzy cache expires. After expiration, the data will be released from the cache.

The out-of-application cache also includes accurate cache and fuzzy cache, where the caching content is similar to that of the in-application cache, which will not repeat here. The expiration time of the out-of-application cache is shorter than that of the in-application cache, that is, the out-of-application cache will expire first, and then the in-application cache expires. Such hierarchical storage in the cache can facilitate the quick call of commonly used data. Different expiration times and different data accuracies of the hierarchical caches are set based on the experience in various practical applications, so that the cache can be released in time, and sufficient storage space can be ensured, thereby controlling the cost and meeting the data requirements of different levels.

TABLE 1
Schematic Table of Multi-Level Cache Mechanism

| Cache type | | Caching content |
|---|---|---|
| In-application cache | Accurate | User |
| | | Current time |
| | | Current position |
| | | Current POI |
| | Fuzzy | Current time (to the hour level) |
| | | Current position (to the grid) |
| | | Current POI |
| Out-of-application | Accurate | User |
| cache | | Current time |
| | | Current position |
| | | Current POI |
| | Fuzzy | Current time (to the hour level) |
| | | Current position (to the grid) |
| | | Current POI |

As shown in FIG. 8, the present disclosure relates to an apparatus for recommending a travel mode, which is configured to implement any of the above-described methods for recommending a travel mode. The apparatus may include:
an analysis module 801, configured to receive a request from a user for querying a first point of interest, and analyze a travel type of the user based on the request;
an alternative module 802, configured to obtain an alternative travel mode based on the travel type in combination with user information;
a cost module 803, configured to calculate a travel cost corresponding to the alternative travel mode; and
a recommendation module 804, configured to recommend at least one travel mode for the user according to the travel cost.

In an example, the analysis module is configured to:
receive a request from the user for querying the first point of interest, and determine a location and a type of the first point of interest;
analyze the location of the first point of interest and a location of the user and determine the travel type of the user as departure or arrival in combination with the type of the first point of interest.

In an example, the alternative module is configured to:
obtain, in a case where the travel type is departure, at least one alternative travel mode conforming to travel habits of the user, in which the user departs from the first point of interest; and
obtain, in a case where the travel type is arrival, at least one alternative travel mode conforming to the travel habits of the user, in which the user arrives at the first point of interest.

In an example, the cost module is configured to:
calculate the travel cost corresponding to the alternative travel mode based on the user information, the related information of the first point of interest, and the travel impact information.

In an example, the recommendation module is configured to:
select a preset number of travel costs after the travel costs are ranked; and
recommend travel modes corresponding to the selected travel costs to the user.

In an example, the recommendation module is further configured to:
provide the user with a reason for selecting the preset number of travel costs as a recommendation reason.

In the examples described above, the travel cost includes at least one of: a time cost, a money cost, and a difficulty cost.

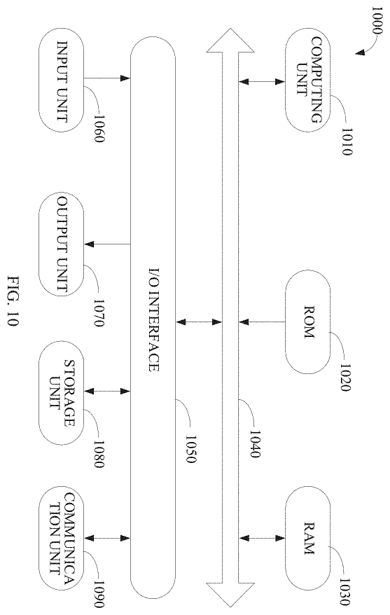

As shown in FIG. 9, the present disclosure relates to an apparatus for recommending a travel mode, which is configured to implement any of the above described methods for recommending the travel mode. The apparatus may include:
an analysis module 901, configured to receive a request from a user for querying a first point of interest, and analyze a travel type of the user;
an alternative module 902, configured to obtain an alternative travel mode based on the travel type in conibination with user information;
a cost module 903, configured to calculate a travel cost corresponding to the alternative travel mode;
a recommendation module 904, configured to recommend at least one travel mode for the user according to the travel cost; and
a comparison module 905, configured to receive a request from the user for querying a second point of interest, recommend, for the second point of interest, at least one travel mode for the user, and display the at least one travel mode recommended for the second point of interest and the travel modes recommended for the first point of interest in a comparison manner.

The functions of the units in each apparatus of embodiments of the present disclosure can be referred to the corresponding descriptions in the methods described above and are not repeated here.

In the technical solutions of the present disclosure, the acquisition, storage and application of the personal information of the user are in compliance with the provisions of relevant laws and regulations, and do not violate public order and good customs.

According to an embodiment of the present disclosure, an electronic device, a readable storage medium, and a computer program product are also provided.

FIG. 10 is a schematic block diagram of an example electronic device 1000 that may be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 10, the electronic device 1000 includes a computing unit 1010, which may perform various appropriate actions and processing according to computer programs stored in a read-only memory (ROM) 1020 or computer programs loaded from a storage unit 1080 to a random access memory (RAM) 1030. The RAM 1030 may further store various programs and data required for the operations of the device 1000. The computing unit 1010, the ROM 1020, and the RAM 1030 are connected to each other via a bus 1040. An input/output (I/O) interface 1050 is also connected to the bus 1040,

A plurality of components in the electronic device 1000 are connected to the I/O interface 1050, including: an input unit 1060, such as a keyboard or a mouse; an output unit 1070, such as various types of displays or speakers; a storage unit 1080, such as a magnetic disk or an optical disc; and a communication unit 1090, such as a network card, a modem, a wireless communication transceiver, etc. The communication unit 1090 allows the electronic device 1000 to exchange information/data with other devices through a computer network such as the Internet, and/or various telecommunications networks.

The computing unit 1010 may be various general-purpose and/or special-purpose processing components with processing and computing capabilities. Some examples of the computing unit 1010 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1010 performs the various methods and processing described above, for example, the method recommending a travel mode. For example, in some embodiments, the method for recommending a travel mode may be implemented as computer software programs, which are tangibly included in a machine-readable medium, such as the storage unit 1080. In some embodiments, a portion or all of the computer programs may be loaded and/or installed onto the electronic device 1000 via the ROM 1020 and/or the communication unit 1090. When the computer programs are loaded to the RAM 1030 and executed by the computing unit 1010, one or more steps of the method for recommending a travel mode described above can be performed. Alternatively, in other embodiments, the computing unit 1010 may be configured, in any other suitable manners (for example, by firmware), to perform the method for recommending a travel mode.

Various implementations of the systems and technologies described herein above may be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include implementing the systems and technologies in one or more computer programs, wherein the one or more computer programs may be executed and/or interpreted on a progarammable system including at least one programmable processor. The programmable processor may he a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes for implementing the method of the present disclosure may be written in any combination of one or more programming languages. These program codes may be provided to processors or controllers of the general-purpose computer, the special-purpose computer, or other programmable data processing apparatuses, such that when the program codes are executed by the processors or the controllers, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may include or store programs for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein may be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein may be implemented in a computing system including a backend component (for example, as a data server), or a computing system including a middleware component (for example, an application server), or a computing system including a frontend component (for example, a user computer with a graphical user interface or a web browser through which the user can interact with the implementations of the systems and technologies described herein), or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated through computer programs running on respective computers and having a client-server relationship with each other. The server may be a cloud server, a server in a distributed system, or a server combined with a blockchain.

It should be understood that steps may be reordered, added, or deleted based on the various forms of procedures described above. For example, the steps described in the present disclosure may be performed in parallel, in order, or in a different order, provided that the desired result of the technical solutions disclosed in the present disclosure can be achieved, which is not limited herein.

The specific implementations described above do not limit the scope of protection of the present disclosure. It will be apparent for those skilled in the art that various modifications, combinations, sub-combinations, and replacements can be made based on design requirements and other factors. Any modifications, equivalent replacements, improvements, etc. within the spirit and principle of the present disclosure shall fall within the scope of protection of the present disclosure.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

What is claimed is:

1. A method, comprising:
receiving a request from a user for querying a first point of interest;
analyzing a travel type of the user based on the request;
obtaining an alternative travel mode based on the travel type in combination with user information;
calculating a travel cost corresponding to the alternative travel mode; and
recommending at least one travel mode for the user according to the travel cost.

2. The method of claim 1, wherein analyzing the travel type of the user based on the request comprises:
determining a location and a type of the first point of interest;
analyzing the location of the first point of interest and a location of the user; and
determining the travel type of the user as departure or arrival in combination with the type of the first point of interest.

3. The method of claim 2, wherein obtaining the alternative travel mode based on the travel type in combination with the user information comprises:
obtaining, in a case where the travel type is departure, at least one alternative travel mode conforming to travel habits of the user, in which the user departs from the first point of interest; and
obtaining, in a case where the travel type is arrival, at least one alternative travel mode conforming to the travel habits of the user, in which the user arrives at the first point of interest.

4. The method of claim 1, wherein calculating the travel cost corresponding to the alternative travel mode comprises:
calculating the travel cost corresponding to the alternative travel mode according to the user information, related information of the first point of interest, and travel impact information.

5. The method of claim 1, wherein recommending at least one travel mode for the user according to the travel cost comprises:
selecting a preset number of travel costs after the travel costs are ranked; and
recommending travel modes corresponding to the selected travel costs to the user.

6. The method of claim 5, further comprising:
providing the user with a reason for selecting the preset number of travel costs as a recommendation reason.

7. The method of claim 1, wherein the travel cost comprises at least one of: a time cost, a money cost, or a difficulty cost.

8. The method of claim 1, further comprising:
receiving a request from the user for querying a second point of interest;
recommending, for the second point of interest, at least one travel mode for the user; and
displaying, in a comparison manner, the at least one travel mode recommended for the second point of interest and the at least one travel mode recommended for the first point of interest.

9. An electronic device, comprising:
at least one processor; and
a memory in communication connection with the at least one processor; wherein
the memory stores instructions executable by the at least one processor that, when executed by the at least one processor, cause the at least one processor to:
receive a request from a user for querying a first point of interest;
analyze a travel type of the user based on the request;
obtain an alternative travel mode based on the travel type in combination with user information;
calculate a travel cost corresponding to the alternative travel mode; and
recommend at least one travel mode for the user according to the travel cost.

10. The electronic device of claim 9, wherein analyzing the travel type of the user based on the request comprises:
determining a location and a type of the first point of interest;
analyzing the location of the first point of interest and a location of the user; and
determining the travel type of the user as departure or arrival in combination with the type of the first point of interest.

11. The electronic device of claim 10, wherein obtaining the alternative travel mode based on the travel type in combination with the user information comprises:
obtaining, in a case where the travel type is departure, at least one alternative travel mode conforming to travel habits of the user, in which the user departs from the first point of interest; and
obtaining, in a case that the travel type is arrival, at least one alternative travel mode conforming to the travel habits of the user, in which the user arrives at the first point of interest.

12. The electronic device of claim 9, wherein calculating the travel cost corresponding to the alternative travel mode comprises:
calculating the travel cost corresponding to the alternative travel mode according to the user information, related information of the first point of interest, and travel impact information.

13. The electronic device of claim 9, wherein recommending at least one travel mode for the user according to the travel cost comprises:
selecting a preset number of travel costs after the travel costs are ranked; and
recommending travel modes corresponding to the selected travel costs to the user.

14. The electronic device of claim 13, wherein recommending at least one travel mode for the user according to the travel cost further comprises:
providing the user with a reason for selecting the preset number of travel costs as a recommendation reason.

15. The electronic device of claim 9, wherein the travel cost comprises at least one of: a time cost, a money cost, or a difficulty cost.

16. The electronic device of claim 9, wherein the instructions, when executed by the at least one processor, further cause the at least one processor to:
receive a request from the user for querying a second point of interest, recommend, for the second point of interest, at least one travel mode for the user, and display, in a comparison manner, the at least one travel mode recommended for the second point of interest and the at least one travel mode recommended for the first point of interest.

17. A non-transitory computer-readable storage medium storing computer instructions, wherein the computer instructions are executed to cause the computer to:
receive a request from a user for querying a first point of interest;
analyze a travel type of the user based on the request;
obtain an alternative travel mode based on the travel type in combination with user information;
calculate a travel cost corresponding to the alternative travel mode; and
recommend at least one travel mode for the user according to the travel cost.

18. The non-transitory computer-readable storage medium of claim 17, wherein analyzing the travel type of the user based on the request comprises:
determining a location and a type of the first point of interest;
analyzing the location of the first point of interest and a location of the user; and
determining the travel type of the user as departure or arrival in combination with the type of the first point of interest.

19. The non-transitory computer-readable storage medium of claim 18, wherein obtaining the alternative travel mode based on the travel type in combination with the user information comprises:
obtaining, in a case where the travel type is departure, at least one alternative travel mode conforming to travel habits of the user, in which the user departs from the first point of interest; and
obtaining, in a case that the travel type is arrival, at least one alternative travel mode conforming to the travel habits of the user, in which the user arrives at the first point of interest.

20. The non-transitory computer-readable storage medium of claim 17, wherein calculating the travel cost corresponding to the alternative travel mode comprises:
calculating the travel cost corresponding to the alternative travel mode according to the user information, related information of the first point of interest, and travel impact information.
